(19) United States
(12) Patent Application Publication
(10) Pub. No.: US 2006/0146272 A1
(43) Pub. Date: Jul. 6, 2006

(54) System and method for continuously supplying and collecting a continuum

(75) Inventors: Jung-Bo Lee, Cheonan-si (KR); Young-Il Kim, Gwacheon-si (KR); Sang-Myung Byun, Cheonan-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/305,441

(22) Filed: Dec. 16, 2005

(30) Foreign Application Priority Data
Dec. 17, 2004 (KR) 10-2004-0108168

(51) Int. Cl. G02F 1/13

(52) U.S. Cl. 349/187

(57) ABSTRACT

A roll-fed system including a supply reel on which a continuum is wound, a cutter for separating a portion of the continuum from the continuum, a transferrer for transferring the continuum, and a plurality of supply controlling pulleys which are disposed between the cutter and a supply reel and move in opposed directions, wherein the continuum is alternately wound on each circumferential surface of the plurality of supply controlling pulleys and is transferred by the transferrer.

### CROSS-REFERENCE TO RELATED APPLICATIONS

This application claims priority to Korean Patent Application No. 10-2004-0108168 filed in the Korean Intellectual Property Office on Dec. 17, 2004, the entire contents of which are incorporated herein by reference.

### BACKGROUND OF THE INVENTION

(a) Field of the Invention

The present invention relates to a system and method for continuously supplying and collecting a roll of material, which can be incorporated in, for example, the manufacturing of liquid crystal displays.

(b) Description of the Related Art

In general, a liquid crystal display includes a pair of display panels on which field generating electrodes are formed, and a liquid crystal layer interposed between the pair of display panels. Liquid crystal molecules of a liquid crystal layer are rearranged by applying voltages to the field generating electrodes, which selectively control the transmittance of light passing through the liquid crystal layer, thereby generating an image.

Voltages are applied to the field generating electrodes by a driving circuit The driving circuit may be an integrated circuit (IC) bonded to an insulative film known as a flexible printed circuit (FPC). The FPC film can be made of material such as polyimide, and may comprise a plurality of conductive lead lines formed on the insulative film. The total structure comprising the IC and the FPC is known as a tape carrier package (TCP).

A TCP may have a plurality of input and output lead lines. The input lead lines are typically soldered to a printed circuit board, which transmits signals to the TCP. The output lead lines are electrically connected to connection pads on the periphery of the LC panel to drive the field generating electrodes.

Typically, TCP's are manufactured using a roll-fed assembly system, in which a continuous roll of FPC known as a “TCP continuum” is fed into a system for processing. The TCP continuum has a number of IC's bonded onto its surface. The TCP continuum is wound on a supply reel and supplied to a series of rollers. The TCP continuum passes underneath a stamp-type cutter mechanism, which successively cuts out sections of the TCP continuum. Each cut-out section forms an individual TCP. The leftover FPC film is then collected on a collection reel and later disposed of.

The TCP bonding system described above may have the following limitations. When the TCP continuum supplied by a supply reel is entirely consumed, it must be replaced with another supply reel having a fresh supply of TCP continuum. Replacing the reel, however, usually requires system operation to be halted, which undesirably increases the total average cycle time (TACT). Similarly, when the collection reel collects a certain amount of leftover FPC film after the cutting process, the collection reel must be replaced, which also halts system operation. Another situation that halts the system is changing a faulty cutter or other component. Furthermore, in a system where a number of machines are operated in series, a problem with one of the machines may require halting the entire system. Thus it is desirable to have an apparatus and method that replaces or repairs system components in a roll-fed system without the need to halt the entire system. As used herein, a roll-fed system refers to any system wherein a continuum is continuously supplied from one reel to at least one roller.

### SUMMARY OF THE INVENTION

The present invention has been made in an effort to provide a system and a method for roll-fed manufacturing having an advantage of being able to continuously operate the system while changing a reel. The invention can also be applied to any system utilizing a roll-fed assembly, such as the manufacture of LCD's, labeling systems or printing systems.

A system for manufacturing LCD's according to an embodiment of the present invention includes a supply reel on which a tape carrier package continuum is wound, a holding part for holding the continuum, a transferrer for transferring the tape carrier package continuum, and a plurality of supply-controlling pulleys which are disposed between the holding part and the supply reel and that move upward and downward, wherein the tape carrier package continuum is alternately wound on each circumferential surface of the plurality of supply controlling pulleys and is transferred by the transferrer.

The system for manufacturing LCD's according to an embodiment of the present invention further includes a first sensor which is disposed between the supply reel and the plurality of supply controlling pulleys, and which senses an end portion of the tape carrier package continuum that is supplied from the supply reel.

The system for manufacturing LCD's according to an embodiment of the present invention further includes a second sensor which is disposed between the transferrer and the cutter and senses an end portion of the tape carrier package continuum.

The system for manufacturing LCD's according to an embodiment of the present invention further includes a first holding part which is disposed between the first sensor and the plurality of supply controlling pulleys and holds the tape carrier package continuum, and a first cutting part which is disposed between the first sensor and the first holding part and that cuts the held tape carrier package continuum.

The system for manufacturing LCD's according to an embodiment of the present invention further includes a first connecting part which is disposed between the first cutting part and the holding part, and that connects an end portion of the cut tape carrier package continuum to an end portion of a tape carrier package continuum of a next supply reel.

In a further embodiment according to the present invention, the first cutting part, the first holding part, and the first connecting part are mounted on one body.

The system for manufacturing LCD's according to an embodiment of the present invention further includes a first recollection reel for collecting a base film which remains after the tape carrier package is separated from the tape carrier package continuum.

The system for manufacturing LCD's according to an embodiment of the present invention further includes a plurality of recollection controlling pulleys which are disposed between the cutter and the first recollection reel, and that move upward and downward;

In another further embodiment according to the present invention, the base film is alternately wound on each circumferential surface of the plurality of recollection controlling pulleys, and is collected by the recollection reel.

The system for manufacturing LCD's according to an embodiment of the present invention further includes a second holding part which is disposed between the plurality of recollection controlling pulleys and the first recollection reel and holds the cut base film, and a second cutting part which is disposed between the second holding part and the first recollection reel and that cuts the held base film.

The system for manufacturing LCD's according to an embodiment of the present invention further includes a second connecting part which is disposed between the second cutting part and the second holding part and connects an end portion of the cut base film to a connection ribbon of the next first recollection reel.

In another further embodiment according to the present invention, the second cutting part, the second holding part, and the second connecting part are mounted on a body.

The system for manufacturing LCD's according to an embodiment of the present invention further includes a second recollection reel for collecting a protective film which is separated from the tape carrier package continuum.

The system for manufacturing LCD's according to an embodiment of the present invention further includes a plurality of supporting parts for supporting or guiding the tape carrier package continuum.

A method for roll-fed manufacturing according to an embodiment of the present invention includes sensing an end portion of the tape carrier package continuum which is supplied from a first supply reel, and moving a plurality of supply controlling pulleys upward or downward in order to supply the tape carrier package continuum which is alternately wound on each circumferential surface of the plurality of supply controlling pulleys.

The method for roll-fed manufacturing according to an embodiment of the present invention further includes providing a next supply reel after removing the first supply reel, and connecting the cut tape carrier package continuum to a tape carrier package continuum of the next supply reel.

In a further embodiment according to the present invention, the providing of a next supply reel is performed while the tape carrier package continuum which is alternately wound on each circumferential surface of the plurality of supply controlling pulleys is continuously supplied.

The method for roll-fed manufacturing according to an embodiment of the present invention further includes cutting the base film after holding the base film which remains after a tape carrier package is separated from the tape carrier package continuum, and moving a plurality of recollection controlling pulleys on which the base film is alternately wound upward or downward, such that the base film is continuously moved thereinto.

In a further embodiment according to the present invention, the cutting of the base film is performed when the base film exceeds capacity of a first recollection reel.

The method for roll-fed manufacturing according to an embodiment of the present invention further includes providing a next first recollection reel after removing the first recollection reel, and connecting the cut base film to a connection ribbon of the next recollection reel.

In another further embodiment according to the present invention, the providing of a next first recollection reel is performed while the plurality of recollection controlling pulleys on which the base film is alternately wound move upward or downward.

The method for roll-fed manufacturing according to an embodiment of the present invention further includes separating the tape carrier package from the tape carrier package continuum which is supplied from the supply reel, and bonding the separated tape carrier package on a connection pad of the liquid crystal panel assembly.

### BRIEF DESCRIPTION OF THE DRAWINGS

FIG. 1 is a schematic view of a system for manufacturing LCD's according to an embodiment of the present invention.

FIG. 2 is a perspective view showing a state in which a tape carrier package, which is separated from a tape carrier package continuum, is being bonded on a liquid crystal panel assembly, in a system for manufacturing LCD's according to an embodiment of the present invention.

FIG. 3 is a schematic view of a first holding part, and a first connecting part, in a system for manufacturing LCD's according to an embodiment of the present invention.

FIG. 4 is a schematic view of a second holding part, a second cutting part, and a second connecting part, in a system for manufacturing LCD's according to an embodiment of the present invention.

FIG. 5 shows an operation of a system for manufacturing LCD's according to an embodiment of the present invention.

FIG. 6 shows an operation of a first holding part, in a system for manufacturing LCD's according to an embodiment of the present invention.

FIG. 7 shows the operation of a first connecting part, in a system for manufacturing LCD's according to an embodiment of the present invention.

FIG. 8 shows the operation of a second holding part and a second cutting part, in a system for manufacturing LCD's according to an embodiment of the present invention.

FIG. 9 shows an operation of a second connecting part, in a system for manufacturing LCD's according to an embodiment of the present invention.

### DESCRIPTION OF REFERENCE NUMERALS INDICATING PRIMARY ELEMENTS IN THE DRAWINGS

11: supply reel
12: second recollection reel
13: first recollection reel
20: tape carrier package continuum
51, 52: supply controlling pulleys
61, 62: recollection controlling pulleys

### DETAILED DESCRIPTION OF THE EMBODIMENTS

The present invention will be described herein with reference to the accompanying figures. Various modifications to the embodiments described herein will also fall within the scope of the present invention. While specific embodiments of the invention are described herein with reference to the manufacturing of LCD panels, it will be understood that the invention applies to any roll-fed assembly system. As used herein, a roll-fed system refers to any system in which a continuum is continuously supplied from one reel to at least one roller.

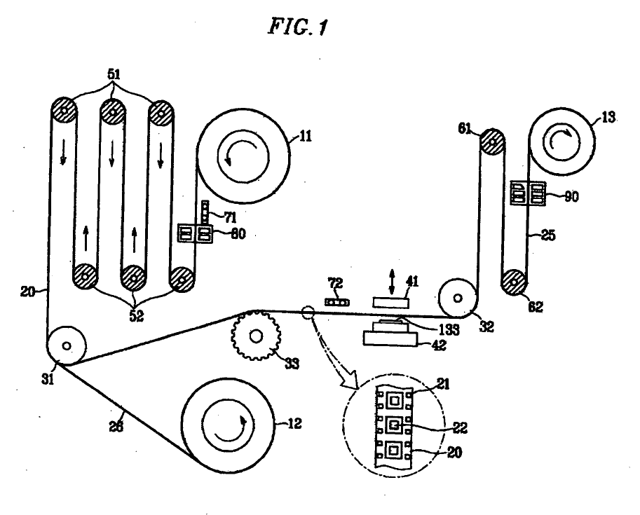

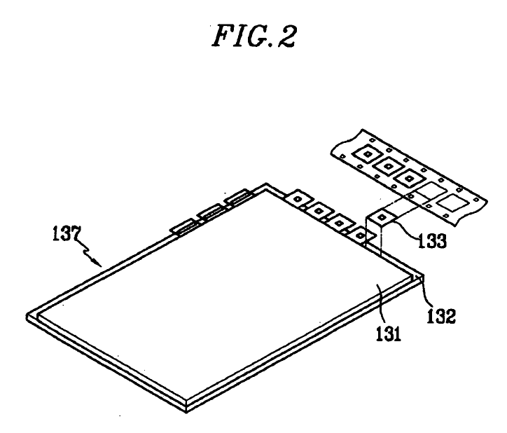

FIG. 1 is a schematic view of a roll-fed system according to an embodiment of the present invention. FIG. 2 is a perspective view showing a state in which a tape carrier package, which is separated from a tape carrier package continuum, is being bonded on a liquid crystal panel assembly, in a system for manufacturing a liquid crystal display according to an embodiment of the present invention.

The steady state operation of the present invention will now be illustrated with reference to FIG. 1. FIG. 1 shows a supply reel 11 supplying a continuous roll of TCP continuum 20. The TCP continuum 20 includes a number of integrated circuit (IC) chips 22 bonded to a base film 25 made of an insulative material such as polyimide. A protective film 26 covers one side of the TCP continuum. The TCP continuum 20 also contains sprocket holes 21 on its lateral ends. Successive sprocket holes 21 are separated from each other by a gap of predetermined distance, such that the sprocket holes 21 align precisely with the teeth of the transferrer 33, allowing smooth transfer of the TCP continuum 20.

Turning now to the operation of the system, the TCP continuum is fed from the supply reel 11 through a first holding unit 80. During steady-state operation, the first holding unit allows the TCP continuum to pass through unimpeded to a series of upper side controlling pulleys 51 and lower side controlling pulleys 52. The TCP continuum contacts the circumferential surfaces of the upper and lower side controlling pulleys 51 and 52, and is drawn across the surfaces of the pulleys to a first supporting part 31. The first supporting part 31 guides the TCP continuum 20. From the supporting part 31, the protective film 26 is separated from the rest of the TCP continuum. The protective film 26 is then provided to the second recollection reel 12. In one embodiment, the protective film 26 may be manually separated from the TCP continuum by a human operator, and the second protective film may be wound to the circumferential surface of the second recollection reel 12 by the human operator. The TCP continuum without the protective film 26 is then supplied to the transferrer 33.

Next, the TCP continuum is supplied to a stamp-type cutter 41 that moves up or down. When the stamp-type cutter 41 moves up, it allows the TCP continuum to pass through underneath it. When the cutter 41 moves down, it cuts out a portion of the TCP continuum passing beneath it. These cut portions form the individual TCP's 133. An individual TCP 133 includes the flexiple printed circuit (FPC) film, and a driving integrated circuit (IC) chip 22 attached to the FPC film. After being cut, the individual TCP 133 is deposited onto a cutter supporter 42. As shown in FIG. 2, the TCP 133 deposited on the cutter supporter 42 can be bonded to a connection pad of a liquid crystal panel assembly 137. The liquid crystal panel assembly 137 includes a thin film transistor (TFT) panel 132, a color filter array panel 131 facing the TFT array panel, and a liquid crystal layer (not shown) interposed between the panels. The separated TCP 133 may be transferred to the assembly 137 by a separate transferer (not shown), and it may be aligned by a separate aligner (not shown).

The remaining uncut portion of the TCP continuum 20 comprises a base film 25, which is transferred to a supporting part 32, an upper side recollection controlling pulley 61, and a lower side recollection controlling pulley 62. The supporting part 32 guides the base film 25. From the recollection control pulleys 61 and 62, the TCP continuum is fed through a second holding body 90, and collected by the first recollection reel 13.

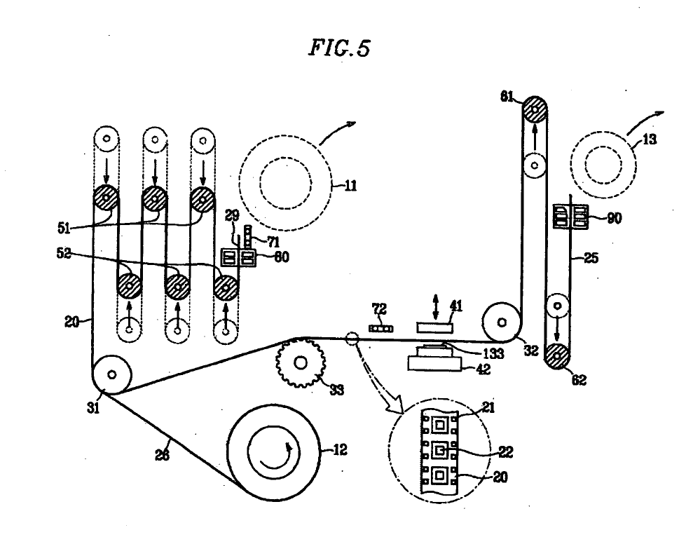

It is seen that according to the present invention, the supply reel 11 continuously feeds TCP continuum 20 to the system to be cut and transferred. When the amount of TCP continuum 20 wound on a supply reel 11 is exhausted, the supply reel 11 should be replaced with a new supply reel 11 that contains a fresh supply of TCP continuum 20. This generally requires halting the entire system. Thus it is desirable to dynamically replace the supply reel 11 while the system is in operation without halting the system. The present invention provides for such dynamic replacement of the supply reel, and this functionality will now be described with reference to FIG. 5.

FIG. 5 shows a supply reel 11 that has been exhausted of TCP continuum 20, as indicated by the trailing edge 29 of the TCP continuum unwound from the supply reel 11. A first sensor 71 is disposed above the first holding body 80 to detect when the trailing edge 29 has been unwound. The sensor may be, for example, a charge-coupled device (CCD) that visually detects the trailing edge 29 of the continuum.

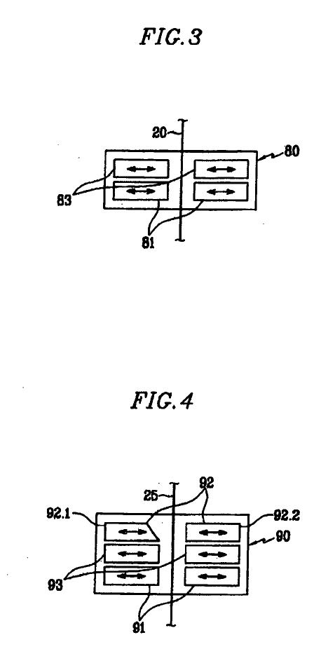

When the sensor 71 detects a trailing edge 29, a series of operations are triggered in the components of the first holding unit 80. FIG. 3 shows the components of the holding unit 80. A first holding part 81 of the holding unit 80 contains two sections that move horizontally toward or away from each other. When the two sections move toward each other, they act to clamp the TCP continuum 20 in place between them. When the two sections move away from each other, they allow the TCP continuum 20 to pass between them. A first connecting part 83 is disposed above the holding part 81, and contains two sections that act in the same manner as the two sections of the holding part. In one embodiment, the connecting part 83 may include a heater (not shown), and the clamping of the two sections of the connecting part 83 applies heat and pressure to to connect the trailing edge of the cut tape carrier package continuum 20 to the leading edge of a TCP continuum of the next supply reel. In addition, the leading edge of the next TCP continuum may be pre-coated with an adhesive (not shown) to facilitate connecting to the trailing edge of the previous TCP continuum.

Referring back to FIG. 5, when the first sensor 71 senses a trailing edge 29 of the TCP continuum 20, the sections of the first holding part 81 in FIG. 3 of the holding unit 80 move together, thereby clamping the TCP continuum 20 between the two sections of the first holding part 81. Meanwhile, the transferrer 33 continues to drive the TCP continuum 20 through the system, thereby pulling the TCP continuum 20 between the point of contact with the transferrer 33 and the point of contact with the first holding part 81. When this pulling force exceeds a certain level, the upper and lower supply controlling pulleys respond by moving down and up, respectively, from their steady-state positions. Alternatively, motors may also be used to facilitate the movement of the upper and lower supply controlling pulleys. The motors may operate in response to the first sensor detecting the trailing edge 29 of the previous TCP continuum. The vertical movement of the pulleys thus allows the TCP continuum 20 to be continuously supplied to the system even while the first holding part 81 clamps one end of the TCP continuum 20 and holds it fixed.

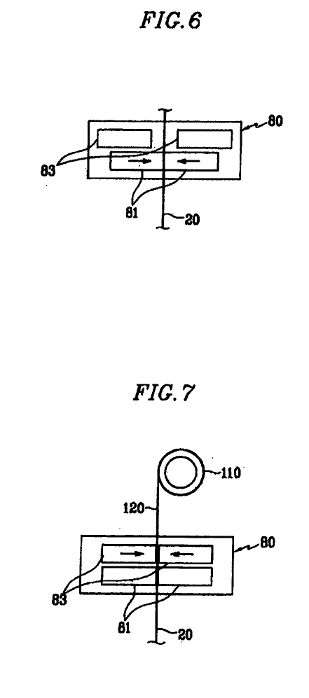

During this time, the exhausted supply reel 11 may be replaced with a new supply reel 11 having a replenished supply of TCP continuum 20. The leading edge of a new sheet of TCP continuum 20 is unwound from the new supply reel 11, and fed through the first holding unit 80 to the first connecting part 83. This is shown in FIG. 7. In FIG. 7, the two sections of the connecting part 83 move together to clamp the trailing edge of the previous TCP continuum to the leading edge of a new sheet of TCP continuum 20. A connection between the trailing edge and the leading edge may be achieved by, for example, providing a heater in the connecting part 83, such that the clamping together of the two sections of the connecting part 83 applies heat as well as pressure to the trailing and leading edges of the continuum, causing them to connect to each other. Alternatively, or in conjunction with a heater, an adhesive may be pre-coated on the leading edge of the new continuum to facilitate the connection between the trailing and leading edges. Once the edges are connected, the first holding part 81 and the connecting part 83 may release the film, the pulleys 51 and 52 may return to their original positions, and steady-state operation may resume.

Because the invention allows the supply reel to be replaced without interrupting system operation, the total average cycle time (TACT) of the system is reduced, thus enhancing the system operating rate and productivity.

Another aspect of the invention is the presence of a second sensor 72 disposed between the transferrer 33 and the stamp-type cutter 41. The second sensor 72 may detect the presence of defects in the TCP continuum, such as the absence of an IC. Such defects may be present in those portions of the TCP continuum 20 where the trailing edge of a TCP continuum is connected to the leading edge of a new TCP continuum, as earlier described with reference to the operation of the connecting part 83. The second sensor 72 may be an image-sensing charge-coupled device (CCD) which detects the presence or absence of an IC, or other defect, by comparing the detected image to a reference image pre-stored in memory. If a defect is detected in the underlying TCP continuum, the stamp-type cutter 41 may bypass the defective portions of the TCP continuum.

The invention can also be applied to keep the system running when the first recollection reel 13 needs to be changed. This may occur when the first recollection reel's 13 capacity for collecting base film 25 is reached. According to this embodiment, the base film 25 is continuously fed through a second holding unit 90. Referring to FIG. 4, the second holding unit 90 is similar to the first holding unit 80 of FIG. 3, and comprises a holding part 91, a connecting part 93, and a cutting part 92. A sensor detects when the capacity of the first recollection reel 13 is reached, for example, by measuring the weight of the base film 25 collected on recollection reel 13. At that time, the two sections of the holding part 91 move together, and clamp the base film 25 between them, as shown in FIG. 8. Thereafter, the cutting part 92 cuts the base film 25, thereby allowing the first recollection reel 13 to be removed and replaced with a new empty recollection reel.

Meanwhile, as the two sections of the holding part 91 clamp the base film 25, the recollection control pulleys adjust their vertical positions away from each other to accommodate the accumulating base film 25. That is, the upper recollection pulley 61 may move up, and the lower recollection pulley 62 may move down, thereby increasing the amount of base film 25 that can be supported between the two pulleys. This allows the system to continuously operate while the recollection reel 13 is replaced, thereby reducing total average cycle time (TACT) and improving system productivity. In one embodiment, movement of the recollection pulleys 61 and 62 may be effected by motors (not shown). It will also be understood that pulleys 61 and 62 may move not only up and down, but in any opposed directions, as long as the distance between them is increased to support additional base film.

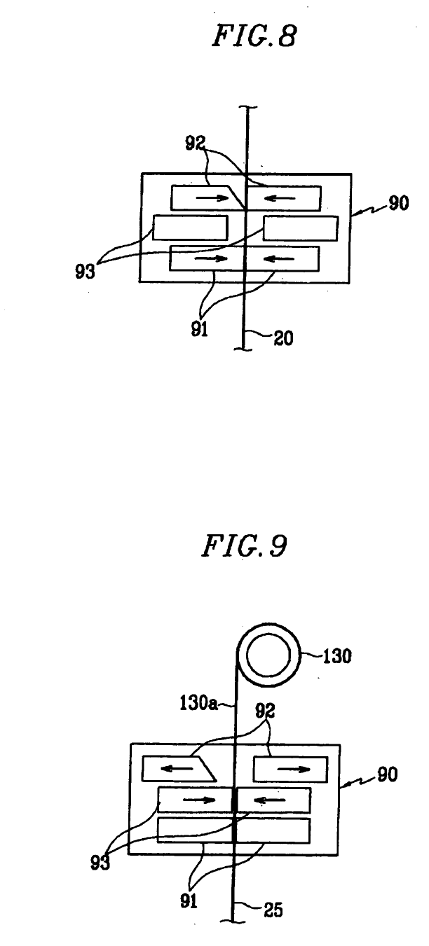

The mechanism by which the base film 25 is loaded onto the next recollection reel 130 will be described with reference to FIG. 9. As shown in FIG. 9, a new recollection reel 130 has replaced the previous recollection reel 13. The next recollection reel is attached to one end of a connection ribbon 130a. The other end of the connection ribbon 130a is positioned in the region between the two sections of the connecting part 93. Note the leading edge of the base film 25 is also present within this region, as a result of the cutter 92 having cut the base film 25. The two sections of the connecting part 93 then move toward each other, thereby clamping one end of the connection ribbon 130a to the trailing edge of the base film 25. The connection ribbon 130a is pre-coated with an adhesive on one side, so that the the ribbon 130a becomes attached to the base film 25 once they are clamped together by the connecting part 93. After the connection ribbon 130a is connected to the base film 25, both the holding part 91 and the connecting part 93 open to release the base film 25. The new recollection reel 130 resumes collecting the base film 25, and the system continues its operation.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. As will be clear from the disclosure, the invention applies not only to the manufacture of LCD panels, but to any roll-fed system, that is, a system supplying a continuum from one reel to at least one roller.

What is claimed is:

1. A roll-fed system comprising:
a supply reel on which a continuum is wound;
a first holding part for holding the continuum;
a transferrer for transferring the continuum; and
a plurality of supply controlling pulleys which are disposed between the first holding part and the supply reel, wherein the supply controlling pulleys can move in opposed directions,
wherein the continuum is alternately wound on each circumferential surface of the plurality of supply controlling pulleys, and is transferred by the transferrer.

2. The system of claim 1, wherein:
the roll-fed system is a system for manufacturing a liquid crystal display;
the continuum is a tape carrier package continuum; and
the first portion is a tape carrier package.

3. The system of claim 1, further comprising a first sensor which is disposed between the supply reel and the plurality of supply controlling pulleys, and that senses an end portion of the continuum which is supplied from the supply reel.

4. The system of claim 1, further comprising a second sensor disposed between the transferrer and the cutter, and that senses a connecting portion of the continuum.

5. The system of claim 3, further comprising a first cutting part which is disposed between the first sensor and the first holding part, wherein the first cutting part cuts the held continuum.

6. The system of claim 5, further comprising a first connecting part disposed between the first cutting part and the first holding part, wherein the first connecting part connects an end portion of the cut continuum to an end portion of a continuum of a next supply reel.

7. The system of claim 5, wherein the first cutting part, the first holding part, and the first connecting part are mounted on one body.

8. The system of claim 1, further comprising a first recollection reel for collecting a base film which remains after the first portion is separated from the continuum.

9. The system of claim 8, further comprising a plurality of recollection controlling pulleys which are disposed between the cutter and the first recollection reel and that can move in opposed directions,
wherein the base film is alternately wound on each circumferential surface of the plurality of recollection controlling pulleys, and is collected by the recollection reel.

10. The system of claim 9, further comprising:
a second holding part which is disposed between the plurality of recollection controlling pulleys and the first recollection reel, and that holds the cut base film; and
a second cutting part which is disposed between the second holding part and the first recollection reel, and that cuts the held base film.

11. The system of claim 10, further comprising a second connecting part which is disposed between the second cutting part and the second holding part, and that connects an end portion of the cut base film to a connection ribbon of the next first recollection reel.

12. The system of claim 11, wherein the second cutting part, the second holding part, and the second connecting part are mounted on a body.

13. The system of claim 1, further comprising a second recollection reel for collecting a protective film which is separated from the continuum.

14. The system of claim 1, further comprising a plurality of supporting parts for supporting or guiding the continuum.

15. A method for roll-fed manufacturing, comprising:
sensing an end portion of a continuum which is supplied from a first supply reel;
upon sensing the end portion of the continuum, holding the continuum; and
moving a plurality of supply controlling pulleys in opposed directions in order to supply the continuum which is alternately wound on each circumferential surface of the plurality of supply controlling pulleys.

16. The method of claim 15, wherein the roll-fed manufacturing method is a method for manufacturing a liquid crystal display, and the continuum is a tape carrier package continuum.

17. The method of claim 15, further comprising:
providing a next supply reel after removing the first supply reel; and
connecting the end portion of the continuum to a continuum of the next supply reel.

18. The method of claim 17, wherein the providing of a next supply reel is performed while the continuum which is alternately wound on each circumferential surface of the plurality of supply controlling pulleys is continuously supplied.

19. The method of claim 15, further comprising:
cutting the base film after holding the base film which remains after a first portion is separated from the continuum; and
moving in opposed directions a plurality of recollection controlling pulleys on which the base film is alternately wound, such that the base film is continuously transferred onto the pulleys.

20. The method of claim 19, wherein the first portion is a tape carrier package.

21. The method of claim 19, wherein the cutting of the base film is performed when the base film exceeds the capacity of a first recollection reel.

22. The method of claim 21, further comprising:
providing a next recollection reel after removing the first recollection reel; and
connecting the cut base film to a connection ribbon of the next recollection reel.

23. The method of claim 22, wherein the providing of a next first recollection reel is performed while the recollection controlling pulleys on which the base film is alternately wound move in opposed directions.

24. The system of claim 15, further comprising
separating the tape carrier package from the tape carrier package continuum which is supplied from the supply reel; and
bonding the separated tape carrier package on a connection pad of the liquid crystal panel assembly.

25. A roll-fed system comprising:
a continuum;
a reel for supplying or collecting the continuum;
a first pulley, wherein the continuum contacts the surface of the first pulley;
a second pulley, wherein the continuum contacts the surface of the second pulley;
a holding part disposed between the reel and the first and second pulleys for holding the continuum or allowing the continuum to pass through; wherein:
the first pulley can move in a first direction while contacting the continuum, and the second pulley can move in a second direction opposed to the first direction while contacting the continuum.

26. The system of claim 25, wherein the reel is for supplying the continuum, the system further comprising a sensor that can sense an end portion of the continuum, and wherein the holding part can hold the continuum in response to the sensor sensing an end portion of the continuum, and the first pulley and second pulley can move in response to the sensor sensing an end portion of the continuum.
system switches from the first phase to the second phase in response to the sensor sensing an end portion of the continuum.

27. The system of claim 25, further comprising a connecting part disposed between the reel and the holding part, wherein the connecting part can connect the continuum to a portion of another continuum.

28. The system of claim 25, further comprising a sensor that can sense when the reel's capacity for collecting continuum is reached, and wherein the holding part can hold the continuum in response to the sensor sensing when the reel's capacity for collecting continuum is reached, and the first pulley and second pulley can move in response to the sensor sensing when the reel's capacity for collecting continuum is reached.

29. The system of claim 28, further comprising a cutter for cutting the continuum, said cutter being disposed between the reel and the holding part.

30. The system of claim 28, wherein the continuum is a tape carrier package continuum.

31. A method for continuously supplying or collecting a continuum, said method comprising:
providing a reel for supplying or collecting the continuum;
providing a first pulley, wherein the continuum contacts the surface of the first pulley;
providing a second pulley, wherein the continuum contacts the surface of the second pulley;
providing a holding part disposed between the reel and the first and second pulleys for holding the continuum or allowing the continuum to pass through; wherein:
during a first phase, the holding part allows the continuum to pass through;
during a second phase, the holding part holds the continuum; and
during the second phase, the first pulley moves in a first direction while contacting the continuum, and the second pulley moves in a second direction opposed to the first direction while contacting the continuum.

32. The method of claim 31, wherein the first pulley and second pulley move away from each other during the second phase.

33. The method of claim 31, wherein the first pulley and second pulley move toward each other during the second phase.

34. The method of claim 31, further comprising providing a cutter disposed between the reel and the holding part, wherein the cutter cuts the continuum during the second phase.

35. The method of claim 31, further comprising switching the first phase to the second phase in response to the sensor sensing that the reel's capacity has been reached.
